(19) United States
(12) Patent Application Publication
(10) Pub. No.: US 2007/0019756 A1
(43) Pub. Date: Jan. 25, 2007

(54) Low complexity soft detection in multiple transmit and receive antenna systems with M-QAM modulations

(75) Inventor: Ahmadreza Hedayat, Allen, TX (US)

Correspondence Address: Howard Chen, Esq.;PRESTON GATES & ELLIS LLP, 55 Second Street, Suite 1700, San Francisco, CA, 94105, US

(73) Assignee: Navini Networks, Inc.

(21) Appl. No.: 11/491,436

(22) Filed: Jul. 21, 2006

Related U.S. Application Data
(60) Provisional application No. 60/702,328, filed on Jul. 25, 2005.

(51) Int. Cl. H04L 5/12

(52) U.S. Cl. 375/261

(57) ABSTRACT

This invention discloses a method for performing soft detection of transmitted signals modulated by M-QAM when a transmitter equipped with one or more transmit antennas, and the receiver has one or more receive antennas. This invention is built based on the fact that soft value of a single transmitted bit (or symbol) has a piece-wise linear behavior as a function of the received signal(s). The methodology to obtain such piece-wise linear functions are given for some M-QAM modulations in single transmit and single receive antenna systems and arbitrary constellation mapping. Also, the methodology is explained for the case where the number of transmit antennas is more than one by an example for 4-QAM modulation and two transmit antennas. A further required process to expand above embodiments to multiple receive antennas are also given.

This application claims priority to and the benefit of U.S. Provisional Application 60/702,328 filed Jul. 25, 2005 entitled “Low Complexity Soft Detection of Multiple Transmit Antenna Systems with M-Qam Modulations.”

### BACKGROUND

The present invention relates generally to a wireless communication system design, and more particularly to a method for reducing the complexity of symbol detections in multiple transmit and receive antenna systems with M-QAM (quadrature-amplitude-modulation) modulations.

Equipping wireless units with multiple transmit and receive antennas, as in a multiple-input, multiple-output (MIMO) system, is a preferred solution in future broadband wireless communication systems, due to their higher capacity and more robust performance. However, multiple transmit antennas expand the size of the original constellation such that every receive antenna observes a constellation whose size has an exponential relationship with the number of transmit antennas. Therefore, the detection of such system could have a significantly higher complexity than a single transmit antenna system.

To reduce the complexity, various sub-optimum algorithms have been designed. Most of these methods perform well when the receiver has more antennas than the transmitter. However, this requirement is not desirable for downlink transmission where it is not economically justified to equip the user unit with more than one antenna. Some other sub-optimum algorithms have a varying level of computational complexity, which is not desirable in practical systems.

The optimum detector of a MIMO system is the maximum likelihood (ML) detector whose complexity grows exponentially with the number of transmit antennas. If the original constellation has M points, using multiple antennas to transmit T independent symbols makes the complexity of ML detector is roughly M^{T}. This effectively prevents the usage of ML detectors in MIMO systems with even moderate size modulations. Therefore, sub-optimum detectors, which can provide a reasonable tradeoff between the complexity and performance, have been of high interest.

Linear processing of the signals received by multiple antennas is a sub-optimum solution with low complexity. When there are more receive antennas than transmit antennas, using zero forcing (ZF) or minimum mean-square error (MMSE) methods, the complexity of the detector can be reduced. However, in most broadband wireless communication systems, since it is preferred to have single-antenna user units, the linear processing is inapplicable.

More recently, there have been other sub-optimum solutions such as nulling and canceling, sphere decoding, and quasi-ML detection. These methods either have the same problem of linear detectors that are exponentially complex when there is a difference in the number of transmit and receive antennas, or have random complexity. These disadvantages prevent the effective implementation of the above algorithms in practice.

For these reasons, it is desirable to design a method for low complexity soft detection in multiple transmit and receive antenna systems with M-QAM modulations without the impairments mentioned above.

### SUMMARY

In view of the foregoing, the following provides a method for low complexity soft detection in multiple transmit and receive antenna systems with M-QAM modulations.

In one embodiment, the method for performing soft detection on signals modulated by M-QAM is disclosed, the method comprising calculating a first and a second probabilities that a selected bit of transmitted symbol is equal to 0 and 1, respectively, calculating Euclidian distances of the first and second probabilities; and obtaining a soft detection value based on a difference between the Euclidian distances of the first and second probabilities, wherein the soft detection value has a piece-wise-linear behavior in terms of the received signal. This invention discloses a method for performing soft detection of transmitted signals modulated by M-QAM, the method comprising calculating a first and a second probability, respectively, that a selected bit of transmitted symbol is equal to 0 and 1 according to

$${λ}_{k , i} ( r , b ) = log {\sum }_{s ∈ {S}_{b}^{k , i}} Pr ( r \text{\textbar} s , h ) ≡ log {\sum }_{s ∈ {S}_{b}^{k , i}} exp ( - \frac{{‖ r - < h , s > ‖}^{2}}{2 {σ}^{2}} ) ,$$

wherein r is a received signal, h is a channel gain, b is 0 or 1, S_{b}^{k,i} represents a subset of an expanded modulation whose symbols have the ith bit of the kth signal equal to bε{0,1}, and σ2 is a normal noise variance, estimating a first and second sub-optimum probabilities, respectively, based on the first and second probabilities according to

$$log {\sum }_{j} {x}_{j} \approx {max}_{j} log {x}_{j} ,$$

and obtaining one or more soft detection values based on a difference between the first and second sub-optimum probabilities.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 illustrates a diagram used to show the soft detected values of the m bits obtained from the sub-optimum Euclidian distance metric of a one transmit antenna system with 16QAM and 64QAM modulations.

FIG. 2 illustrates a diagram used to show the soft detected values obtained from the sub-optimum Euclidian distance metric of a two-transmit-antenna system with 16QAM modulation and a random channel realization.

FIG. 3 illustrates a diagram used to show the soft detected values obtained from the sub-optimum Euclidian distance metric of a two transmit antenna complex random channel where each antenna uses a 4QAM modulation, and a random channel realization.

FIG. 4 illustrates the method for low complexity soft detection in a system with multiple receive antennas according to one embodiment of the invention.

### DESCRIPTION

The following will provide a detailed description of a method for low complexity soft detection in multiple transmit and receive antenna systems with M-QAM modulations.

An optimum way to perform the soft detection begins by assuming a single receive antenna and a number of transmit antennas T, and that some knowledge of the channel gain, h=(h₁, h₂, . . . , h_{T}) is obtained at the receiver. Given the received signal r, the probability that the i^{th} bit of the transmitted symbol Sₖ is equal to bε{0,1}, can be calculated by this following equation:

$${λ}_{k , i} ( r , b ) = log {\sum }_{s ∈ {S}_{b}^{k , i}} Pr ( r \text{\textbar} s , h ) ≡ log {\sum }_{s ∈ {S}_{b}^{k , i}} exp ( - \frac{{‖ r - < h , s > ‖}^{2}}{2 {σ}^{2}} ) ,$$

Where, <.,.> is the inner product operation, and S_{b}^{k,i} represents a subset of the expanded modulation whose symbols have the i^{th} bit of the k^{th} signal equal to b, and σ² is the normal noise variance. The log-likelihood ratio (LLR) of the i^{th} bit of the transmitted symbol Sₖ is then equal to the difference of the above probability for the two choices of b, i.e. Γ_{k,i}(r)=λ_{k,i}(r,0)−λ_{k,i}(r,1).

Depending on the constellation size and the number of transmit antennas T, the above metric calculation could be a complex computation. Using the approximation

$$log {\sum }_{j} {x}_{j} \approx {max}_{j} log {x}_{j} ,$$

the sub-optimum Euclidian distance metric is:

$${λ}_{k , i} ( r , b ) = {max}_{s ∈ {S}_{b}^{k , i}} log Pr ( r \vert s , h ) \approx {min}_{s ∈ {S}_{b}^{k , i}} {‖ r - < h , s > ‖}^{2} .$$

ML detectors require evaluating above expression for all kε{1, 2, . . . , T} and iε{1, 2, . . . , M}, where M is the size of the modulation used by each antenna.

Despite that the minimum value (min) in the calculation of λ_{x,i}(r,b) is a nonlinear operation, this invention is based on a simple observation that the soft detected value Γ_{k,i}(r)=λ_{k,i}(r,0)−λ_{k,i}(r,1) has a piece-wise linear behavior in terms of the received signal r. Hence, obtaining or approximating the linear equation of the soft detected value Γ_{k,i}(r) also provides the soft detection of the transmitted bits and symbols.

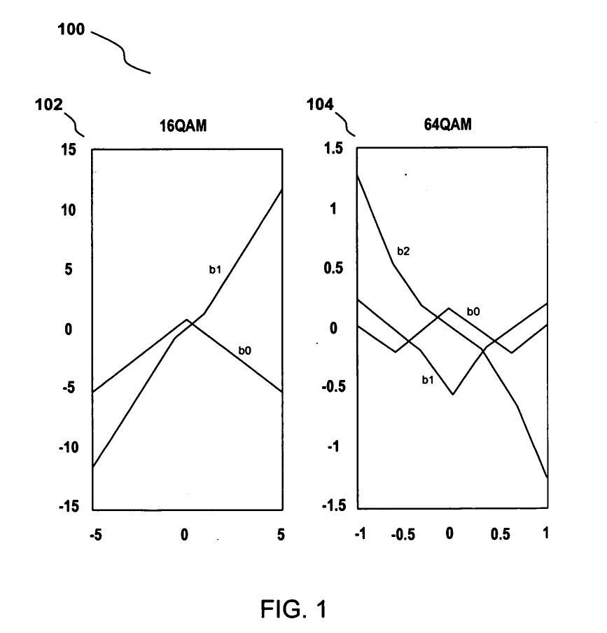

FIG. 1 illustrates a diagram 100 comprising two graphs 102 and 104 that are used to show the soft detected values of the m bits obtained from the sub-optimum Euclidian distance metric of the example 16QAM and 64QAM modulations, in one transmit antenna systems, in accordance with one embodiment of the present invention.

The symmetry of M-QAM constellation with Gray mapping simplifies the soft detection such that, in the additive white Gaussian noise (AWGN) channel (when h=1), the Γᵢ(r) of i-bit depends either on Re(r) or Im(r). In the graphs 102 and 104, the soft detected values of the m bits, M=2^{m}, obtained from the sub-optimum Euclidian distance metric are shown where the horizontal axis is Re(r) or Im(r). In the graph 102, the soft detected values b₀ and b₁ for the 16QAM modulation are shown while the soft detect values b₀, b₁, and b₂ for 64QAM modulation are shown in the graph 104. Note that b₀ represents the soft value Γ_{0,0}, b₁ represents the soft value Γ_{0,1}, and b₁ represents the soft value Γ_{0,2}.

For fading channel, the soft values depend on both Re(r) and Im(r) and have a similar shape as the curves within the graphs 102 and 104 with the possibility of being shifted and/or expanded. This is due to the constellation rotation that is caused by complex fading coefficient h. However, the soft detected values, Γᵢ(r), still have piece-wise linear behavior.

In an example scenario where the complex fading h is represented as h=hᵣ+jhᵢ, r=rᵣ+jrᵢ, the soft values for a 4QAM modulation are:
Γ₀(r)=4(rᵣhᵢ−rᵢhᵣ), Γ₁(r)=−4(rᵣhᵣ+rᵢhᵢ).

For a 16QAM modulation, given by f₀=8(hᵣ²+hᵢ²), f₁=4(rᵣhᵢ−rᵢhᵣ), f₂=4(rᵣhᵣ+rᵢhᵢ), the soft detected values of the four bits are:
Γ₀(r)=|f₁|−f₀, Γ₁(r)=max(|f₁|,2|f₁|−f₀)sgn(f₁)
Γ₂(r)=|f₂|−f₀, Γ₄(r)=max(|f₂|,2|f₂|−f₀)sgn(f₂)

For 64QAM modulation, given by f₀=8(hᵣ²+hᵢ²), f₁=4(rᵣhᵢ−rᵢhᵣ), f₂=4(rᵣhᵣ+rᵢhᵢ), the soft detected values of the four bits are:
Γ₀(r)=max(−|f₁|+f₀,|f₁|−3f₀)
Γ₁(r)=min(|f₁|−2f₀,2|f₁|−3f₀)
Γ₂(r)=max(|f₁|,2|f₁|−f₀,3|f₁|−3f₀,4|f₁|−6f₀)sgn(f₁)
Γ₃(r)=max(−|f₂|+f₀,|f₂|−3f₀)
Γ₄(r)=min(|f₂|−2f₀,2|f₂|−3f₀)
Γ₅(r)=max(−|f₂|,−2|f₂|+f₀,−3|f₂|+3f₀,−4|f₂|+6f₀)sgn(f₂)

One can use this methodology to obtain similar expressions for general M-QAM modulation whether the mapping is gray, such as the above example, or not.

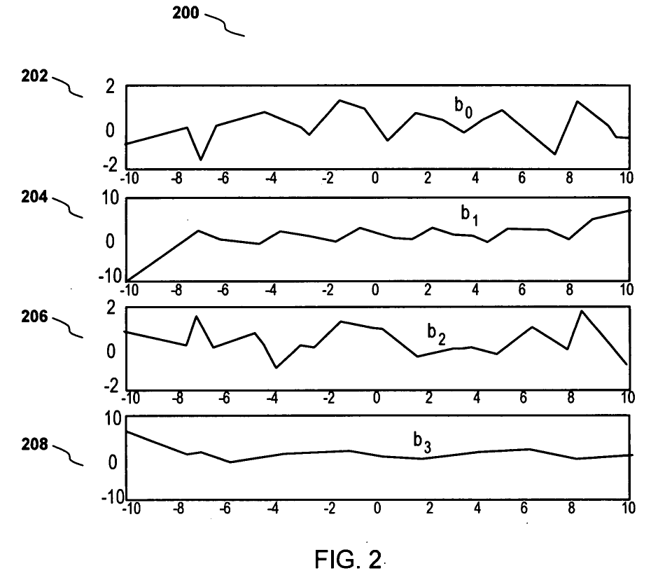

FIG. 2 illustrates a diagram 200 comprising four graphs 202, 204, 206, and 210 that are used to show the soft detected values obtained from the sub-optimum Euclidian distance metric of a two-transmit-antenna channel with 16QAM modulation and a random channel realization in accordance with one embodiment of the present invention.

When T antennas, T=2 in this example, simultaneously transmit independent signals, the received signal at the single-antenna receive at a given time instance is

$$r = {\sum }_{k = 1}^{T} {h}_{k} {S}_{k} + n ,$$

where hₖ is the channel gain of the k^{th} transmit antenna and n is the white normal noise. With the above equation, it is clear that the receiver observes an effective constellation with size M^{T}. However, the soft detected value Γ_{k,i}(r) still has piece-wise linear behavior, for all kε{1, 2, . . . , T} and iε{1, 2, . . . , M}.

In the graph 202, the soft detected value b₀ or Γ_{0,0} for the 16QAM modulation is shown while the soft detect values b_{1 or} Γ_{0,1} is shown in the graph 204. The soft detected value b₂ or Γ_{0,2} for the 16QAM modulation is shown in the graph 206, and the soft detect values b₃ or Γ_{0,3} is shown in the graph 208. Note that the horizontal axes are Re(r) while Im(r) is fixed in the graphs 202, 204, 206, and 208. For illustration purposes graphs 202, 204, 206, and 208 present only at a random realization of the two-transmit-antenna systems (with 16QAM modulation).

To simplify the process of determining the linear equations of each soft values Γ_{k,i}(r), the following procedure can be performed. Consider an exemplary scenario of a two-transmit antenna system, T=2, where |h₀|<|h₁|, φ₀=∠h₀, and φ₁=∠h₁, the minimum angle θ which aligns the two M-QAM rotated constellations can be obtained. Note that M-QAM constellations are π/2 invariant, therefore θ=mod(φ₁,π/2)−mod(φ₀,π/2) and |θ|<π/4. Instead of actual channel (h₀,h₁)=(|h₀|∠φ₀,|h₁|∠φ₁), an assumption of the channel being (|h₀|∠φ₀+θ,|h₁|∠φ₁) can be made. This rotation and subsequently calculating Γ_{k,i}(r) based on it makes the algorithm sub-optimal. However, it provides some needed properties for Γ_{k,i}(r) and enables easy calculation of the linear equations' coefficients that Γ_{k,i}(r) are calculated from.

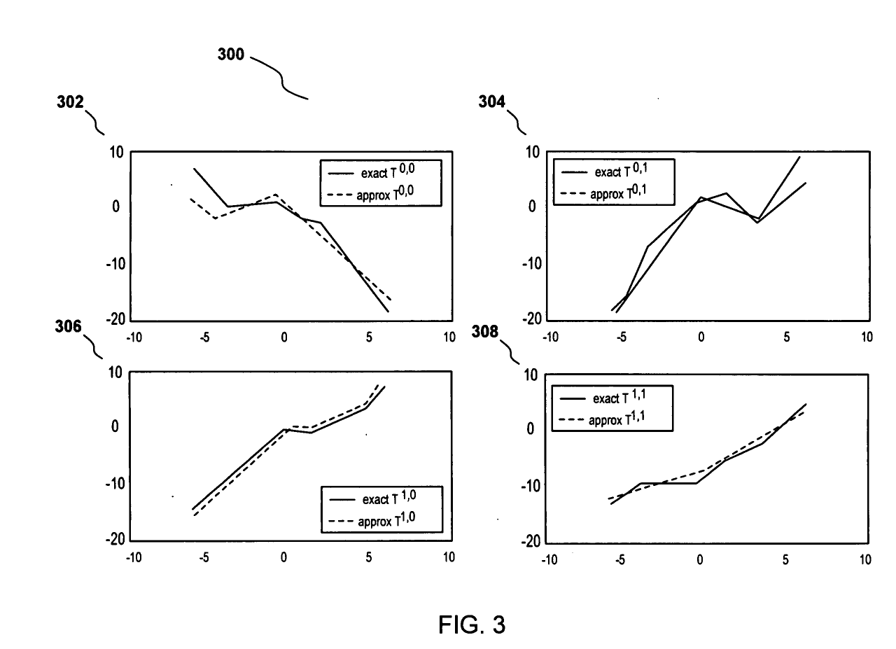

FIG. 3 illustrates a diagram 300 comprising four graphs 302, 304, 306, and 308 that are used to show the soft detected values obtained from the sub-optimum Euclidian distance metric of a two transmit antenna complex random channel where each antenna uses a 4QAM modulation in accordance with one embodiment of the present invention. For illustration purpose, diagram 300 presents a random realization of the two-transmit-antenna systems (with 16QAM modulation).

In the example illustrated in graph 302, the soft detected values Γ_{k,i}(r), k=0,1 and i=0,1, are shown where the horizontal axis is Re(r) and Im(r) is equal to −2. In the graph 302, the exact and approximate values of the soft detected value Γ_{0,0} are shown while the exact and approximate values of the soft detect value Γ_{0,1} are shown in the graph 304. The exact and approximate values of the soft detected value Γ_{1,0} are shown in the graph 306, and exact and approximate values of the soft detected value Γ_{1,1} are shown in the graph 308. For all four graphs 302, 304, 306, and 308, the exact soft detected values Γ_{k,i}(r) are obtained from the ML detector and are represented by the solid line while the approximate soft detected values Γ_{k,i}(r) are obtained from previously shown algorithms and are represented by the dotted lines.

The graphs 302, 304, 306, and 308 demonstrate that there is a difference between Γ_{k,i}(r) obtained from the ML detector and the above sub-optimum algorithm. The difference depends on the random channel coefficients and most importantly on the ratio of |h₀/h₁| and θ. The larger the ratio |h₀|/|h₁| and the smaller the θ are, the smaller the difference is.

For T=2 and 4QAM, the representation of Γ_{k,i}(r) is in the general form of:

$${Γ}_{k , i} ( r ) = \{ \begin{matrix}{a}_{k , j} {h}_{p} + {b}_{k , j} R , & Re ( r ) < {t}_{k , j} \\ {c}_{k , j} {h}_{p} + {c}_{k , j} R , & {t}_{k , j} \leq Re ( r ) < {w}_{k , j} \\ {d}_{k , j} {h}_{p} + {e}_{k , j} R , & {w}_{k , j} \leq Re ( r )\end{matrix} ,$$

where the results R=Re(h₁r*) or R=Im(h₁r*) are possible depending on k,i. With hₚ=|h₀|*|h₁|, the coefficients a_{k,i}, b_{k,i}, c_{k,i}, d_{k,i}, e_{k,i} are either fixed or are linear functions of the ratio |h₀|/|h₁|, and the threshold t_{k,j}, w_{k,j} are functions of the Im(r), h₁, and hₚ. Note that the above representation can be extended to other constellations where the line Re(r) is segmented to more portions, compared to the three portions above, but still with the same linear relationship on hₚ and R.

For systems with more than one receive antennas above embodiments need to be performed for each receive antenna separately, and for each k, i, the resulting Γ_{k,i}(r) of each receive antenna is added according to

$$r = {\sum }_{k = 1}^{T} {h}_{k} {S}_{k} + n ,$$

where hₖ is the channel gain of the k^{th} transmit antenna, and n is the white normal noise.

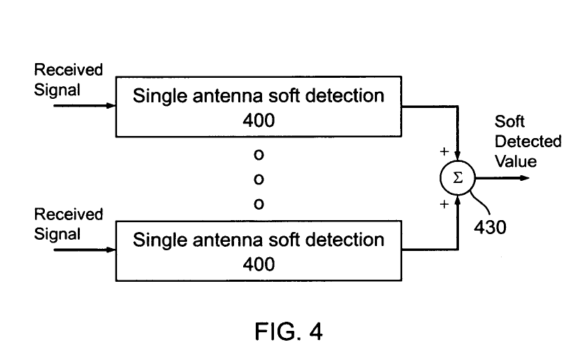

FIG. 4 illustrates the aforementioned method for low complexity soft detection in a system with multiple receive antennas according to one embodiment of the invention. Values obtained from single antenna soft detections 400 are added, and a sum 430 still preserves the linearity.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for performing soft detection of transmitted signals modulated by M-QAM, the method comprising:
calculating a first and a second probability, respectively, that a selected bit of transmitted symbol of the transmitted signal is equal to 0 and 1 according to
$${λ}_{k , i} ( r , b ) = log {\sum }_{s ∈ {S}_{b}^{k , i}} Pr ( r \text{\textbar} s , h ) ≡ log {\sum }_{s ∈ {S}_{b}^{k , i}} exp ( - \frac{{‖ r - < h , s > ‖}^{2}}{2 {σ}^{2}} ) ,$$
wherein r is a received signal, h is a channel gain, b is 0 or 1, S_{b}^{k,i} represents a subset of an expanded modulation whose symbols have the i^{th} bit of the k^{th} signal equal to bε{0, 1}, and σ² is a normal noise variance;
estimating a first and second sub-optimum probabilities, respectively, based on the first and second probabilities according to
$$log {\sum }_{j} {x}_{j} \approx {max}_{j} log {x}_{j} ;$$
and
obtaining one or more soft detection values based on a difference between the first and second sub-optimum probabilities.

2. The method of claim 1 further comprising:
transmitting the signals by a first predetermined number of transmit antennas;
receiving the transmitted signals by a second predetermined number of receive antennas;
calculating the soft detection value for signals received by each receive antenna; and
summing all the soft detection values calculated from each receive antenna to obtain a true soft detection value.

3. The method of claim 2, wherein the first predetermined number is one.

4. The method of claim 2 further comprising obtaining the transmitted signals by combining all the received signals by a single receive antenna according to
$$r = {\sum }_{k = 1}^{T} {h}_{k} {S}_{k} + n ,$$
where hₖ is the channel gain of the k^{th} transmit antenna, and n is the k=1 white normal noise, when the first predetermined number of transmit antenna is greater than one.

5. The method of claim 2, wherein the second predetermined number is one.

6. The method of claim 2, wherein the second predetermined number is greater than one.

7. A method for performing soft detection of transmitted signals modulated by M-QAM, the method comprising:
transmitting the signals by a first predetermined number of transmit antennas;
receiving the transmitted signals by a second predetermined number of receive antennas;
calculating a first and second probabilities, respectively, that a selected bit of transmitted symbol of the transmitted signal is equal to 0 and 1 according to
$${λ}_{k , i} ( r , b ) = log \sum Pr ( r \vert s , h ) ≡ log {\sum }_{s ∈ {S}_{b}^{k , i}} exp ( - \frac{{‖ r - < h , s > ‖}^{2}}{2 {σ}^{2}} ) ,$$
wherein r is a received signal, h is a channel gain, b is 0 or 1, S_{b}^{k,i} represents a subset of an expanded modulation whose symbols have the i^{th} bit of the k^{th} signal equal to bε{0,1}, and σ² is a normal noise variance;
estimating a first and second sub-optimum probabilities, respectively, based on the first and second probabilities according to
$$log {\sum }_{j}^{} {x}_{j} \approx {max}_{j} log {x}_{j} ;$$
obtaining one or more soft detection values based on a difference between the first and second sub-optimum probabilities for each receive antenna independently; and
summing all the soft detection values calculated from each receive antenna to obtain a true soft detection value.

8. The method of claim 7, wherein the first predetermined number is one.

9. The method of claim 7 further comprising obtaining the transmitted signals by combining all the received signals by a single receive antenna according to
$$r = {\sum }_{k = 1}^{T} {h}_{k} {S}_{k} + n ,$$
where hₖ is the channel gain of the k^{th} transmit antenna, and n is the white normal noise, when the first predetermined number of transmit antenna is greater than one.

10. The method of claim 7, wherein the second predetermined number is one.

11. The method of claim 7, wherein the second predetermined number is greater than one.

12. A method for performing soft detection of transmitted signals modulated by M-QAM, the method comprising:
transmitting the signals by a plurality of transmit antennas;
receiving the transmitted signals by a single receive antennas;
combining all the received transmitted signals according to
$$r = {\sum }_{k = 1}^{T} {h}_{k} {S}_{k} + n ,$$
where hₖ is a channel gain of the k^{th} transmit antenna, and n is a white normal noise;
calculating a first and second probabilities, respectively, that a selected bit of transmitted symbol of the transmitted signal is equal to 0 and 1 according to
$${λ}_{k , i} ( r , b ) = log {\sum }_{s ∈ {S}_{b}^{k , i}} Pr ( r \vert s , h ) ≡ log {\sum }_{s ∈ {S}_{b}^{k , i}}^{} exp ( - \frac{{‖ r - < h , s > ‖}^{2}}{2 {σ}^{2}} ) ,$$
wherein r is a received signal, h is a channel gain, b is 0 or 1, S_{b}^{k,i} represents a subset of an expanded modulation whose symbols have the i^{th} bit of the k^{th} signal equal to bε{0,1}, and σ² is a normal noise variance;
estimating a first and second sub-optimum probabilities, respectively, based on the first and second probabilities according to
$$log {\sum }_{j}^{} {x}_{j} \approx {max}_{j} log {x}_{j} ;$$
and
obtaining one or more soft detection values based on a difference between the first and second sub-optimum probabilities.
